(19) United States
(12) Patent Application Publication
(10) Pub. No.: US 2022/0227278 A1
(43) Pub. Date: Jul. 21, 2022

(54) Mat connector structure

(71) Applicant: FORMOSA SAINT JOSE CORPORATION, TAIPEI (TW)

(72) Inventor: Ming-Shun Yang, Taipei (TW)

(73) Assignee: FORMOSA SAINT JOSE CORP., Taipei (TW)

(21) Appl. No.: 17/572,639

(22) Filed: Jan. 11, 2022

(30) Foreign Application Priority Data
Jan. 18, 2021 (TW) 110102027

(51) Int. Cl. B60N 3/04

(52) U.S. Cl. CPC B60N 3/046

(57) ABSTRACT

The present invention discloses a mat connector structure for cars, used to connect two overlapping mats to a connection pole on a car floor. The mat connector structure includes a buckle block, a first connecting unit, at least one second connecting unit, and at least one third connecting unit in relative to the second connecting unit. With the implementation of the present invention, the mat connector structure, being convenient to install or disassemble, is easy to setup or remove the overlapping mats rapidly; adaptive to a variety of cars without being limited by the size or shape of the connection poles on cars; and with the first connecting unit and the second connecting unit being formed in different positions on the buckle block, debris, mud, water drops or other liquid are all contained on the mats without being leaking or dropping out to the car floor. Further, the mat connector structure can be custom designed according to the car type or car model, meeting various kinds of car usage habits or specific image promotion arrangements of the car manufacturer or dealers.

### BACKGROUND OF THE INVENTION

### 1. Technical Field

The present invention relates to a mat connector structure, and more particularly, to a mat connector structure with a first connecting unit and a second connecting unit located in different locations on a buckle block.

### 2. Description of Related Art

Car mats are used in almost 100% of the cars, not just to contain water drops, mud or debris, but also to provide more comfort, anti-slip and safety promotion of driving. That is, with proper use of mats not only help to maintain the neatness in a car, but also help to reduce safety concerns or unpredictable dangers of the driver, the passengers or the people on the road.

Applications of double mats or two mats stacked together are for further providing of better improvements for comfort or safety, especially in poor weather conditions.

However, every known existing products or applications of double mats or two mats stacked together in the market are basically two mats stacked together on the existing connection pole on a car floor at practically the same vertical position.

In practice, such kind of connection suffers from the limitations of the existing connection pole or connection unit that generally cannot provide enough length or space for the thickness of the two mats stacked and added together. Or when sometimes two mats can be used together by luck, sand, stones, debris, water drops, juice, mud or other liquid constantly leaks from the upper mat to the lower mat through the connecting position, and then leaks to the car floor at the stacking position of the connection pole and leaves stains that are hard to clean.

This results in the needs for a creative and contributive invention of a mat connector structure with years of experience and knowledge accumulation to have a dedicated connection for the first mat and the second mat and arrange the connection place of the two mats deviated away from the position of the connection pole or connection unit on the car floor, thus not only the stacking of the mats is not limited by the length or type of the connection pole or connection unit on the car floor, water drops or debris are also prevented from leaking into the car floor due to the connection place of the two mats being arranged deviated away from the position of the connection pole or connection unit on the car floor.

Besides, the mat connector structure can be custom made to provide a dedicated design for any specific car type or model to help providing other commercial requirements or image promotion for enterprises.

### SUMMARY OF THE INVENTION

The present invention discloses a mat connector structure for cars, used to connect two overlapping mats to a connection pole on a car floor. The mat connector structure includes a buckle block, a first connecting unit, at least one second connecting unit, and at least one third connecting unit in relative to the second connecting unit. With the implementation of the present invention, the mat connector structure, being convenient to install or disassemble, is easy to setup or remove the overlapping mats rapidly; adaptive to a variety of cars without being limited by the size or shape of the connection poles on cars; and with the first connecting unit and the second connecting unit being formed in different positions on the buckle block, debris, mud, water drops or other liquid are all contained on the mats without being leaking or dropping out to the car floor. Further, the mat connector structure can be custom designed according to the car type or car model, meeting various kinds of car usage habits or specific image promotion arrangements of the car manufacturer or dealers.

The present invention provides a mat connector structure, used to fix a first mat and an overlapping second mat to a connection pole on a car floor, comprising: a buckle block, formed by a sturdy material and is fixed at the first mat; a first connecting unit, being formed on the buckle block, is detachably connected to the connection pole; at least one second connecting unit, formed at a position other than the first connecting unit on the buckle block; and at least one third connecting unit, being firmly fixed on the second mat in a position corresponding to the second connecting unit, wherein each said third connecting unit is one-to-one detachably connected to a said second connecting unit.

Implementation of the present invention at least involves the following inventive steps:

1. Convenient design for quick installation of the stacked mats to the connection pole on the car floor.

2. Designing of connecting units to eliminate limitations from the connection pole or connection unit on the car floor.

3. Debris, water drops, snow or liquids are limited on the first mat or the second mat without leaking to the car floor due to the deviated position design of the first connecting unit from the second connecting unit.

4. The mat connector structure can be custom made to provide a dedicated design for any specific car type or model to help providing other commercial requirements or image promotion for enterprises.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE SEVERAL VIEWS OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a schematic three-dimensional view of a mat connector structure according to an embodiment of the present invention.

FIG. 2 is a schematic three-dimensional view of a buckle block implemented with a first connecting unit and a second connecting unit according to an embodiment of the present invention.

FIG. 3 is a schematic three-dimensional view of a first connecting unit further implemented with a cover according to an embodiment of the present invention.

FIG. 4 is a schematic three-dimensional view of a recessed area implemented at the second connecting unit in relative to the cover of the first connecting unit according to an embodiment of the present invention.

FIG. 5 is a schematic three-dimensional view of a third connecting unit implemented corresponding to a second connecting unit according to an embodiment of the present invention.

FIG. 6 is a schematic three-dimensional view of the mat connector structure shown in FIG. 5 with at least a wrinkle area further formed on the surface of the protrusion rod of the second connecting unit according to an embodiment of the present invention.

FIG. 7 is a schematic three-dimensional view of a third connecting unit implemented corresponding to a second connecting unit according to another embodiment of the present invention.

FIG. 8 is a schematic three-dimensional view of the mat connector structure shown in FIG. 7 with at least a wrinkle area further formed on the surface of the protrusion rod of the third connecting unit according to an embodiment of the present invention.

FIG. 9 is a schematic three-dimensional view of a mat connector structure with plural locking grooves further formed on the first connecting unit to hold at least two corresponding locking protrusions further formed at the cover according to an embodiment of the present invention.

FIG. 10 is a schematic three-dimensional view of applying at least one mat connector structure to fix the first mat and the overlapping second mat to the connection pole or connection poles on a car floor in a way that one mat connector structure is used for one connection pole according to an embodiment of the present invention.

### DETAILED DESCRIPTION OF THE EMBODIMENTS OF THE INVENTION

Embodiments together with illustrating graphs reference are provided hereafter for further understanding and recognizing of the realization of the present invention.

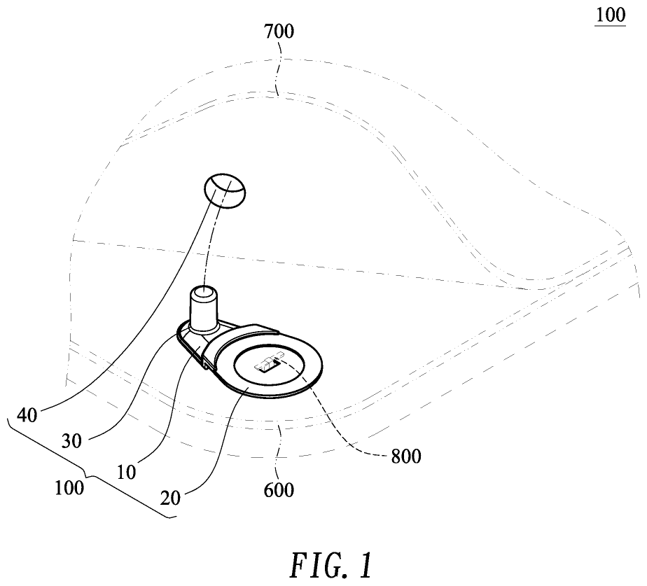

Please refer to FIG. 1, in an embodiment of the present invention, a mat connector structure 100, used to fix a first mat 600 and an overlapping second mat 700 to a connection pole 800 on a car floor, comprises: a buckle block 10; a first connecting unit 20; at least one second connecting unit 30; and at least one third connecting unit 40.

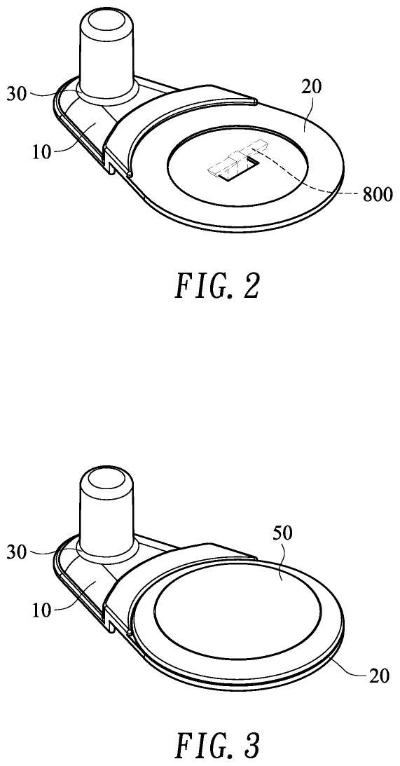

Referring to in FIG. 1 and FIG. 2, the buckle block 10, being a sturdy and easy to form or built block body fixed at the first mat 600, is a block body not restricted on its shape or size. While sturdy and easy to form buckle block 10 can be made of an alloy or other strong and light materials.

As also shown in FIG. 1 and FIG. 2, the first connecting unit 20, being formed on the buckle block 10, is detachably connected to the connection pole 800 on the car floor. Said first connecting unit 20 can be formed in one piece together with the buckle block 10 for reducing manufacturing process and cost saving.

The outlook of the first connecting unit 20 can be a ring shape structure with the center of the ring accepts and contains the connection pole 800 while the entire first connecting unit 20 is connected attached to the first mat 600 with the ring body.

And as shown in FIG. 3, the first connecting unit 20 can further include a cover 50. The cover 50 included fits perfectly with the first connecting unit 20 and fully covers the center portion of the first connecting unit 20.

As such, with the cover 50 covering the first connecting unit 20, and thus covers the connection pole 800 connecting the first connecting unit 20 to the car floor, debris, mud, water drops, snow or other liquids brought or fallen into the car can be contained and restricted on the first mat 600 or the second mat 700 without leaking through the connection pole 800 to the car floor.

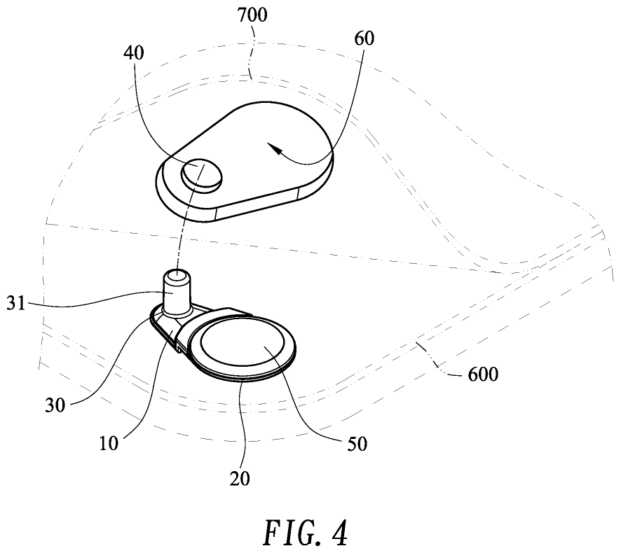

Please refer then to FIG. 4, a recessed area 60 can be further formed on the surface of the second mat 700 that contacts the first mat 600. The size of the recessed area 60 can be made to contain both the buckle block 10 and the cover 50 to make the second mat 700 stacks tight with the first mat 600.

Please refer again to FIG. 1 and FIG. 2, at least one second connecting unit 30 is formed at a position other than the first connecting unit 20 on the buckle block 10.

With this important feature of the deviated position design of the first connecting unit 20 from the second connecting unit 30, there will be no gap or hole going directly from above the stacked first mat 600 and the second mat 700 through the first mat 600 and the second mat 700 at the connection pole 800 to the car floor, and thus debris, water drops, snow or liquids carried into the car are limited on the first mat 600 or the second mat 700 and cannot leak to the car floor.

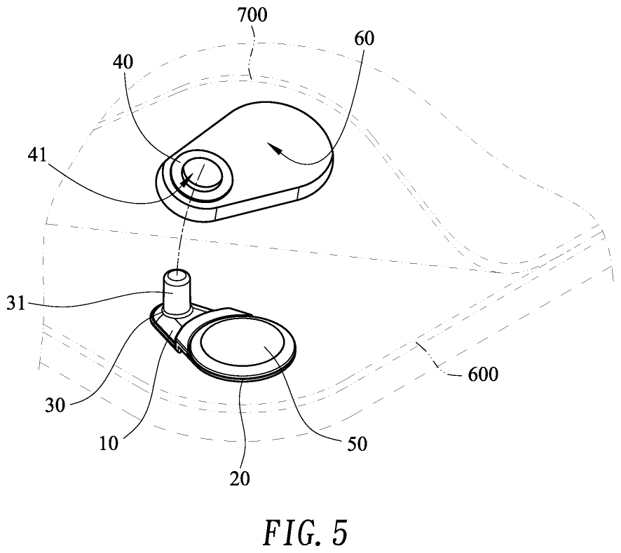

Please refer now to FIG. 1 and FIG. 5, the mat connector structure 100 includes at least one third connecting unit 40, which is firmly fixed on the second mat 700 in a position corresponding to the second connecting unit 30 on the first mat 600, wherein each said third connecting unit 40 is one-to-one detachably connected to a second connecting unit 30.

In an embodiment, each second connecting unit 30 includes a protrusion rod 31 and a corresponding depression 41 is formed on the third connecting unit 40 to accept the protrusion rod 31. The second mat 700 can be firmly stacked on the first mat 600 with the protrusion rod 31 fits tight into the corresponding depression 41.

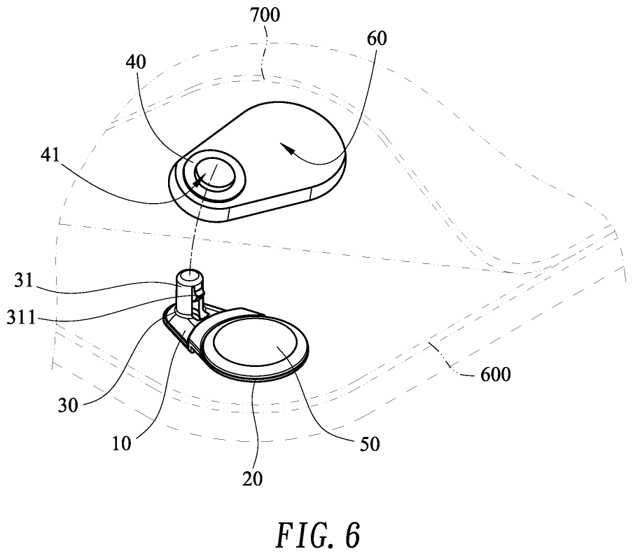

Furthermore, as shown in FIG. 6, at least a wrinkle area 311 can be further formed on the surface of the protrusion rod 31. The protrusion rod 31 can fit even better into the depression 41 with at least a wrinkle area 311 built on and make the second mat 700 stack even tighter to the first mat 600.

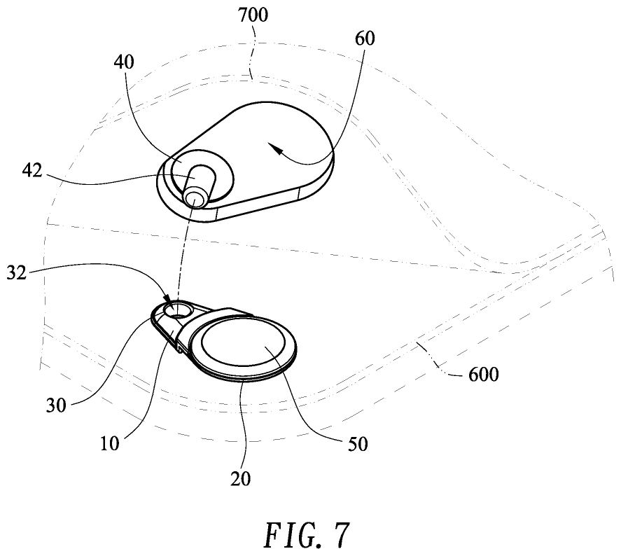

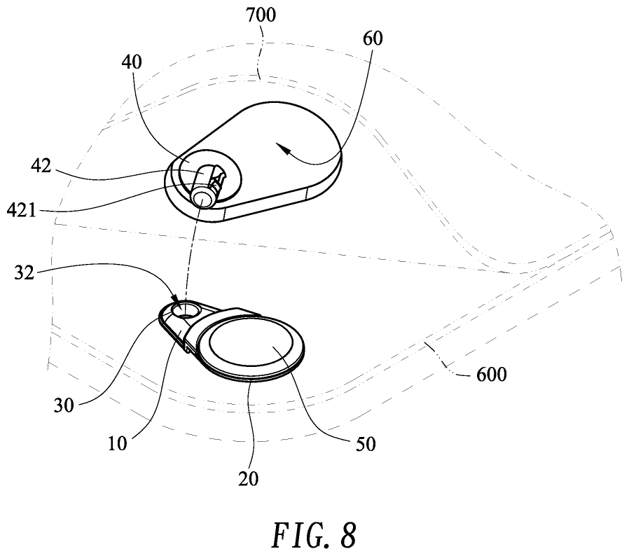

While as shown in FIG. 7 and FIG. 8, in another embodiment, the connection structures can also be implemented otherwise, with a depression 32 formed on the second connecting unit 30 and a corresponding protrusion rod 42 formed on the third connecting unit 40. Of course, at least a wrinkle area 421 can also be formed on the surface of the protrusion rod 42 to effectively promote the combination strength of the protrusion rod 42 and the depression 32.

In certain embodiments other than the discussed as shown I FIG. 5 to FIG. 8, the connection method for connecting the second connecting unit 30 and the third connecting unit 40 can also be chosen from Velcro, buttons, buckling, hooking or zipping together.

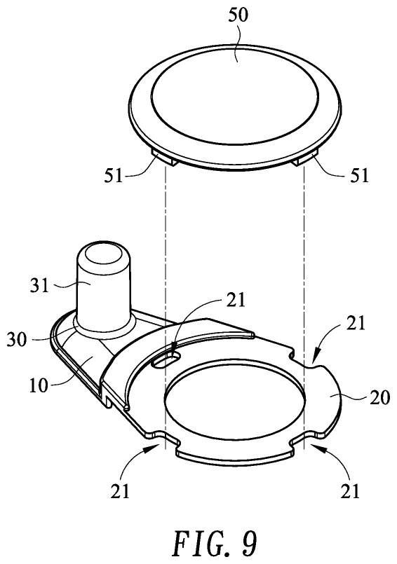

Then as shown in FIG. 9, in embodiments of mat connector structure 100 with a cover 50, plural locking grooves 21 can be further formed on the first connecting unit 20 to hold at least two corresponding locking protrusions 51 further formed at the cover 50. With the locking protrusions 51 locked in the locking grooves 21, rotation of the cover 50 on the buckle block 10 that often causes connection failure of cover 50 can be effectively prevented.

In certain embodiments, the locking grooves 21 can be formed on the rim of the ring structure of the first connecting unit 20 with equal distance between any two neighboring locking grooves 21, or be formed in a radiating pattern from the center of the ring structure.

All in all, the mat connector structure 100 of the present invention is not only designed for quick installation of the stacked mats to the connection pole on the car floor; eliminates limitations from the connection pole or connection unit on the car floor; being able to be custom made to provide a dedicated design for any specific car type or model to help providing other commercial requirements or image promotion for enterprises; and moreover, with the innovative deviated position design of the first connecting unit 20 from the second connecting unit 30, debris, water drops, mud, snow or other liquids carried or fallen into the car are restricted on the first mat 600 or the second mat 700 without leaking to the car floor.

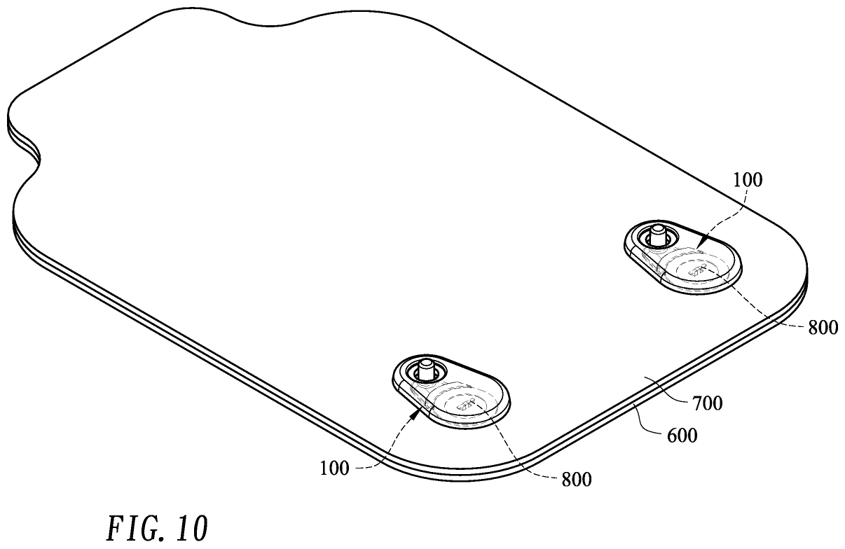

Further, as shown in FIG. 10, when in car applications, at least one mat connector structure 100 can be applied to fix the first mat 600 and the overlapping second mat 700 to at least a connection pole 800 on the car floor in a way that one mat connector structure 100 is used for one connection pole 800. When in some of the applications, 2 mat connector structures 100 are frequently used.

The embodiments described above are intended only to demonstrate the technical concept and features of the present invention to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. A mat connector structure, used to fix a first mat and an overlapping second mat to a connection pole on a car floor, comprising:
a buckle block, formed by a sturdy material and is fixed at the first mat;
a first connecting unit, being formed on the buckle block, is detachably connected to the connection pole;
at least one second connecting unit, formed at a position other than the first connecting unit on the buckle block; and
at least one third connecting unit, being firmly fixed on the second mat in a position corresponding to the second connecting unit, wherein each said third connecting unit is one-to-one detachably connected to a said second connecting unit.

2. The mat connector structure according to claim 1, wherein said first connecting unit is a ring type structure.

3. The mat connector structure according to claim 1, wherein said first connecting unit further includes a cover.

4. The mat connector structure according to claim 3, wherein a recessed area is further formed on the second mat to just accommodate the buckle block and the cover.

5. The mat connector structure according to claim 1, wherein the second connecting unit further includes a protrusion rod, and wherein the third connecting unit includes a depression for fitting tight the protrusion rod.

6. The mat connector structure according to claim 5, wherein at least a wrinkle area is further formed on the surface of the protrusion rod.

7. The mat connector structure according to claim 1, wherein the third connecting unit further includes a protrusion rod, and wherein the second connecting unit includes a depression for fitting tight the protrusion rod.

8. The mat connector structure according to claim 7, wherein at least a wrinkle area is further formed on the surface of the protrusion rod.

9. The mat connector structure according to claim 3, wherein plural locking grooves are further formed on the first connecting unit to hold at least two corresponding locking protrusions further formed at the cover.

10. The mat connector structure according to claim 1, wherein at least one mat connector structure is applied to fix the first mat and the overlapping second mat to at least a connection pole on a car floor in a way that one mat connector structure is used for one connection pole.

11. The mat connector structure according to claim 2, wherein at least one mat connector structure is applied to fix the first mat and the overlapping second mat to at least a connection pole on a car floor in a way that one mat connector structure is used for one connection pole.

12. The mat connector structure according to claim 3, wherein at least one mat connector structure is applied to fix the first mat and the overlapping second mat to at least a connection pole on a car floor in a way that one mat connector structure is used for one connection pole.

13. The mat connector structure according to claim 4, wherein at least one mat connector structure is applied to fix the first mat and the overlapping second mat to at least a connection pole on a car floor in a way that one mat connector structure is used for one connection pole.

14. The mat connector structure according to claim 5, wherein at least one mat connector structure is applied to fix the first mat and the overlapping second mat to at least a connection pole on a car floor in a way that one mat connector structure is used for one connection pole.

15. The mat connector structure according to claim 6, wherein at least one mat connector structure is applied to fix the first mat and the overlapping second mat to at least a connection pole on a car floor in a way that one mat connector structure is used for one connection pole.

16. The mat connector structure according to claim 7, wherein at least one mat connector structure is applied to fix the first mat and the overlapping second mat to at least a connection pole on a car floor in a way that one mat connector structure is used for one connection pole.

17. The mat connector structure according to claim 8, wherein at least one mat connector structure is applied to fix the first mat and the overlapping second mat to at least a connection pole on a car floor in a way that one mat connector structure is used for one connection pole.

18. The mat connector structure according to claim 9, wherein at least one mat connector structure fixes the first mat and the overlapping second mat to at least a connection pole on a car floor wherein one mat connector structure is used for one connection pole.
